(19) United States
(12) Patent Application Publication
(10) Pub. No.: US 2005/0170132 A1
(43) Pub. Date: Aug. 4, 2005

(54) Multi-layer optical information storage medium and method of making the same

(76) Inventor: Han H. Nee, Newport Coast, CA (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/961,686

(22) Filed: Oct. 11, 2004

Related U.S. Application Data
(60) Provisional application No. 60/510,029, filed on Oct. 9, 2003.

(51) Int. Cl. B32B 3/02

(52) U.S. Cl. 428/64.4

(57) ABSTRACT

A new multi-layer optical disc structure with semi-reflective and highly reflective layers suitable for the next generation optical information storage medium is disclosed. The medium has three information layers each has about 20 Giga-bytes of storage capacity, a substrate with a thickness between 0.35 to 0.42 mm, suitable for use with a 400 to 450 nm wavelength playback laser, and a player with an objective lens with a NA between 0.65 to 0.78. New methods of making the multi-layer discs are also disclosed. A parting layer comprising a material that is relatively easy to separate from a reflective or fully semi-reflective layer is used along with polycarbonates substrates to make intermediate disc structures. The parting layer may include metal such as, for example, tin, zinc, antimony, cadmium, gallium, thallium, lead, bismuth, selenium or their mixtures. The parting layer may also include organic materials. The methods are suitable for producing multiple layer optical information storage media, for example. DVD-14, or DVD-18.

### PRIORITY CLAIM

This Application claims the benefit of U.S. Provisional Patent Application Ser. No. 60/510,029 filed on Oct. 9, 2003, the entirety of which is incorporated herein by reference.

### FIELD OF THE INVENTION

This invention relates to multiple layer optical information storage media and method of making the optical storage media where the media may comprise multiple layers that include information.

### BACKGROUND

The current generation of optical information medium is typically composed of one or two information layers. For example, U.S. Pat. No. 6,544,616; discloses an optical disc structures such as a DVD-5 (one layer disc) or DVD-9 (two layer or dual-layer disc). Recently, disc format such as DVD-14 (3 layers) and DVD-18 (4 layers), which have multiple layers have became popular.

The manufacturing process of such multi-layer discs typically involves the process of making a precursor disc of a DVD-9 with one substrate made of polycarbonate and another substrate made of PMMA (polymethyl mythacrylate). See for example U.S. Pat. No. 5,900,098. A semi-reflective layer material such as, for example, gold is applied by sputtering the metal on the polycarbonate substrate and the reflective layer composed of a metal such as, for example, an aluminum alloy is applied by sputtering to the PMMA substrate. Next the two substrates are glued together with UV cured adhesive. Subsequently, the PMMA substrate is peeled off leaving a 0.6 mm thick polycarbonate substrate with 2 layers of information. Similarly another polycarbonate substrate with 2 layers of information is prepared. Next, the two polycarbonate substrates, each with as many as 2 layers of information pits, are glued together with a hot melt type or UV cured type of adhesive to form a DVD-18 with 4 layers of information.

The manufacturing process and the construction of DVD's are described in various prior arts such as U.S. Pat. Nos. 6,007,889; 6,544,616; 6,117,284; and 5,540,966 which are included herein by reference. Briefly, referring to FIG. 1, the construction of a multi-layer disc 10 such as a DVD-14 (with 14 gigabytes of storage capacity). Components 30 and 40 are transparent substrates about 0.6 mm in thickness. The information substrate is typically made from polycarbonate. A thin semi-reflective layer 31 is made from, for example, pure gold or a silver alloy. Spacer 32 is made from UV cured resin. Highly reflective layers, 33 and 35 are typically made from an aluminum alloy. A glue or adhesive 34 can be of the hot melt type or a UV cured type. Final objective lenses 20, 21 and 22 focus the reading beam (laser beam with wavelength at 650 nanometers) on to the information pits and lands of the optical information storage device. When the reading laser beam (not shown) is focused on 33, it must pass through semi-reflective layer 31 and transparent substrate 30 twice before reaching the detector (not shown) in the player. Optional UV cured protective lacquers (not shown) may be positioned on either side of adhesive 34. There are three information layers in disc structure 10. One information structure 35 is read from one side it commonly has a storage capacity of about 5 gigabytes. The other two information structures 31, 33 are read from the opposite side. Both 31 and 33 may have about 4.5 gigabytes of storage capacity. The total storage capacity of all three sides is about 14 gigabytes. Alternatively, there may be a second information layer (not shown) on the same side as 35, giving a device with 4 information layers. Each layer in a device having 4 information layers, has 4.5 gigabytes of storage capacity creating a device with a total storage capacity of about 18 gigabytes.

Briefly, with reference to FIG. 2, a method of manufacturing DVD-14 or DVD-18 is disclosed in U.S. Pat. No. 6,117,284 is as follows. For a dual-layer DVD-9 110 one side of the disc is made with a transparent substrate such as polymethyl methacrylate or PMMA 140 that is 0.6 mm thick. Substrates are made by an injection molding process and the use of a suitable stamper. The stamper is generally elctroformed from a nickel material with the suitable information features or pits on the stamper surface. The other transparent substrate 130 is usually made of polycarbonate and has a thickness of 0.6 mm, it is also made by an injection molding process and use of a nickel stamper. Generally the two substrates have different feature patterns or pits. Subsequently, a semi-reflective layer 131 of a material such as gold is coated on to the polycarbonate substrate 130 by a sputtering process. Next and a highly reflective layer 133 is coated on the PMMA substrate 140 by a sputtering process. The two half-discs are then glued together using an adhesive typically of the UV curing type. Typically, of the all the layer interfaces the aluminum reflective layer and the PMMA have the weakest adherence to one another. The relatively weak adherence of the aluminum layer and the PMMA substrate enable the PMMA layer to be mechanically peeled from the rest of the DVD-9 structure as illustrated in FIG. 2.

The result is a 0.6 mm thick substrate of polycarbonate with two information layers, a semi-reflective layer 131, and a highly reflective layer 133. Subsequently, a second half-disc also 0.6 mm thick with two information layers can be made using the same process illustrated in FIG. 2. These two half-discs can then be bonded together by a hot-melt adhesive (not shown). Additional protective layers disposed on either side of the hot melt adhesive may be added to the structure to provide additional corrosion protection to the metal layers in the disc. Thus a DVD with four information layers, for example a DVDS-18 can be made this way. If the second 0.6 mm thick half-disc has only one information layer and it is bonded to a second half-disc having only one information layer, a disc with two information layers is formed. For example, a DVD-14 can be formed by bonding two DVD-5 half-discs, each with a 0.6 mm thick polycarbonate structure and one information surface, to one another. Thus in the manufacture of both DVD-14s and DVD-18s, 0.6 mm thick polycarbonate and PMMA substrates are only used as intermediates steps in the process of making the final discs. After the disc is made, the PMMA half-discs are peeled-off and discarded or recycled.

Although the above mentioned process can be used to manufacture DVD-14 or DVD-18, the use of a PMMA as a disposable intermediate has several shortcomings. First, PMMA material is relatively brittle as compared to polycarbonate, it cracks easier than polycarbonate. Secondly, injection molding of PMMA is much more problematic than injection molding of polycarbonate, resulting in a lower process yield. Thirdly, PMMA may be more expensive than polycarbonate. These concerns add to the cost of manufacturing optical storage devices of using PMMA as an intermediate in the process. There is a need then, for a more cost-effective process for manufacturing DVD-14s, DVD-18s, and other multi-layer optical discs than the one currently used.

Recent advances in the development of thin silver alloy films for use as both semi-reflective and highly reflective layers in DVD-9s has made it feasible to create tri-layer and even quadruple-layer optical discs with all playback information layers on one side of the disc. See for example, U.S. Pat. Nos. 6,007,889, and 6,280,811. Combined with objective lens having a numerical aperture (NA) of 0.60, playback lasers having a wavelength of 650 nm, and double layer same side playback capability, a multiple-layer disc DVD-14 with 14 gigabytes of information storage or DVD-18 with 18 gigabytes of information storage capacity can be made.

Various formats for the next generation optical discs have been proposed. One of these is referred to so as a “blu-ray” disc. The blu-ray disc system is characterized by a playback laser operating at a wavelength at about 405 nm (blue light) and an objective lens with 0.85 numerical aperture. The storage capacity of this device, used with one information layer, is estimated to be about 25 gigabytes. Because the focal depth of an objective lens with a NA of 0.85, is typically less than one micron, the tolerance of the optical path length variation is drastically reduced relative to currently used systems. Thus a cover layer about 100 microns thick (the distance is measured from the surface of the disc to the information layer) has been proposed. The variation of the thickness of this cover layer is extremely critical to the success of this system. For example, a 2 or 3 micron thickness variation in the cover layer will introduce very high spherical aberration in the playback signal, potentially degrading the signal to an unacceptable level. Currently, no simple commercial process, exists to manufacture a 100 microns thick cover layer with accuracy of one micron. This constitutes a major weakness of this format, standing in the way of it becoming the standard for the next generation of optical discs. An additional concern with this format is that the structure of the blu-ray disc is so different from current optical storage discs that new production equipment must be put into place to manufacture the blu-ray discs. The need for a new generation of manufacturing equipment to produce the blu-ray discs is expected to substantially increase the cost of manufacturing the blu-ray discs. These anticipated increased production costs presents another obstacle in the way of adopting the blu-ray format as the industry wide standard for the next generation of DVD.

In part because of the aforementioned problems associated with the “blu-ray disc”, another format for the next generation of DVD has been proposed. This proposed format is referred to as “advanced optical disc” (AOD) it is also referred to as “high density digital video disc” or HD-DVD. The AOD format preserves some of the feature of current DVD. For example, it comprises two 0.6 mm thick two half-discs glued together to create a symmetrical structure. The AOD system uses a playback laser with a wavelength of 405 nm and an objective lens with a NA of about 0.65. The storage capacity of the AOD disc with one information layer is about 15 gigabytes. Although manufacturing a AOD disc is less complicated and less challenging than manufacturing a “blu-ray disc”, it suffers one significant drawback. The playback signal quality of any disc is a strongly dependant upon the flatness of the disc. In order to deal with the variation of disc flatness in introduced in the mass production of AOD discs, a tilt servo mechanism in the player is needed. The need for this mechanism will increase the cost of players required to read AOD discs.

Recently in SPIE Proceedings vol. 4090 (year 2000), page 43-47, a prerecorded optical disc with 0.3 mm thickness substrate played back with a blue laser was disclosed. The disc was made with three substrates with 0.3, 0.6 and 0.3 mm thickness respectively. This disc structure can have two information layers played back from two opposite sides. This means that user has to remove the disc from the player in order to read the second information layer, an inconvenience for the user. Furthermore, the three substrates are not of equal thickness. The use of substrates with different thicknesses may complicate the production process compared to using substrates with equal thickness thereby increasing the cost of the process. Additionally, the structure is not conducive to the manufacture of media that includes more than two information layers.

It is one objective of the current invention to address the problem of making DVD-14, 18 or other multi-layer optical discs. One aspect of the current invention addresses these limitations by using polycarbonate to make the intermediates in the manufacture of DVD-9 and DVD-18, thereby lowering the cost of making multi-layer optical discs such as DVD-18.

There is a need then for a next generation optical storage disc structures that is easier to manufacture and makes better use of existing manufacturing machinery than the currently proposed structures.

### SUMMARY OF THE INVENTION

One embodiment is a new method for manufacturing optical storage devices that includes using a parting layer to aid in the transfer of a reflective or semi-reflective layer from a intermediate substrate to multi-layer optical information storage device.

Another embodiment is a disc format for use in the next generation of DVD that costs less to produce and use than either the “blu-ray” or AOD systems.

One embodiment is an optical disc format is that uses a playback device incorporating a laser operating in the 400 to 450 nm range, an objective lens with a NA in the range of 0.65 to 0.78, and a transparent substrate about 0.35 to 0.42 mm thick. This new format disc is about 5 inches in diameter and has a storage capacity of about 20 gigabytes per layer. Dual layer and tri-layer disc will have storage capacity of about 40 and 60 gigabytes respectively. This is expected to be enough storage capacity to store a high definition TV program when the data is encrypted using a typical signal compression technique such as MPEG 2 or MPEG 4. Because the NA (numerical aperture) of the playback lens is lower than the “blu-ray disc”, disc the player specifications are less critical enabling the use of a more robust easier to manufacture system. These considerations translate into a more dependable and less expensive system.

Another embodiment provides a new disc manufacturing process to make the proposed next generation multi-layer disc. This process can also be used to manufacture DVD-14 or DVD-18 using conventional substrates such as polycarbonate without the need to use PMMA and other similar materials as substrates in the process. One embodiment includes introducing a layer of material layer between the transparent substrate with information features and a highly reflective layer such as aluminum alloys or silver alloys that has a relatively weak affinity for the highly reflective layer. The layer with a weak affinity for the material of the reflective layer functions as a ‘parting layer’. The parting layer may include a metal preferably a soft metal with a melting point preferably between 100 and 450° C., or form an organic material. Preferred metal for use in the parting layer include metals such as tin, bismuth, cadmium, selenium, gallium, thallium, lead, zinc, and their alloys. Any binary alloys or ternary alloys selected from the above mentioned group of metals and metal alloys can also be used for this application.

The process of making and using a parting layer to manufacture optical storage discs includes the following steps. Forming a polycarbonate substrate with information features. Applying a parting layer in the form of, for example, a soft metal layer to the substrate with the information features, by for example, sputtering. Applying a highly reflective or semi-reflective layer comprised of, for example, metals as aluminum, aluminum alloy, silver or silver alloys or the like, by, for example, sputtering. In one embodiment another substrate can be made with another polycarbonate disc having information features. The information surface of the second disc can be coated with a semi-reflective layer such as, for example, a thin silver alloy layer by, for example, sputtering. The two half-discs can be glued together using a UV cured adhesive. The parting layer can then be peeled off from the whole disc, leaving one half-disc with two information layers. This process can be repeated to make another substrate which also has two information layers. Both substrates (each, for example, with two information layers) can then be further bonded together using a UV cured adhesive or a hot melt process. This process can be use to make multi-layer optical discs such as DVD-18s and the like.

### BRIEF DESCRIPTION OF THE DRAWINGS

FIG. 1. A cross-sectional view of an optical information storage device, which includes three information layers.

FIG. 2. A cross-sectional view, of an intermediate step in the process of manufacturing an optical storage device, for example, a DVD-14.

FIG. 3. A cross-sectional view of some processing steps that may be used to make a multi-layer optical disc.

FIG. 4. A schematic cross-sectional view of an optical information storage disc, which includes four information layers.

FIG. 5. A schematic cross-sectional view of an optical disc information storage device, which includes three information layers.

FIG. 6. A schematic cross-sectional view of an optical information storage device which includes three substrates.

FIG. 7. A schematic cross-sectional view, of an optical information storage device, which includes two substrates with at least the capacity to include information and a dummy substrate.

### DETAILED DESCRIPTION OF THE EMBODIMENTS

Referring now to FIG. 2, is preferable to mold the information pits in polycarbonate substrate rather than PMMA as depicted in. However, the step of peeling off the substrate from the half-disc information layer is almost impossible when polycarbonate is used in place of PMMA. When a 0.6 mm thick layer of polycarbonate substrate is peeled from substrates layers 131 and 133, both 131 and 133 are often damaged. When layer 140 is made with polycarbonate substrate, the structure 110 is a standard DVD-9 disc. Trying to peel off polycarbonate substrate 140 from the rest of the disc structure often destroys various interfaces within the disc and eventually the entire disc. This is because polycarbonate tightly adheres to the aluminum layer often used in reflective layer 133. In contrast PMMA substrate does not adhere as tightly to the aluminum highly reflective layer 133 as does a polycarbonate substrate. Therefore, if a polycarbonate substrate is to be used to replace PMMA is the DVD-14 or 18 process as described and illustrated in FIG. 2, a method is needed to weaken the adhesion between the polycarbonate structure and the reflective layer 133.

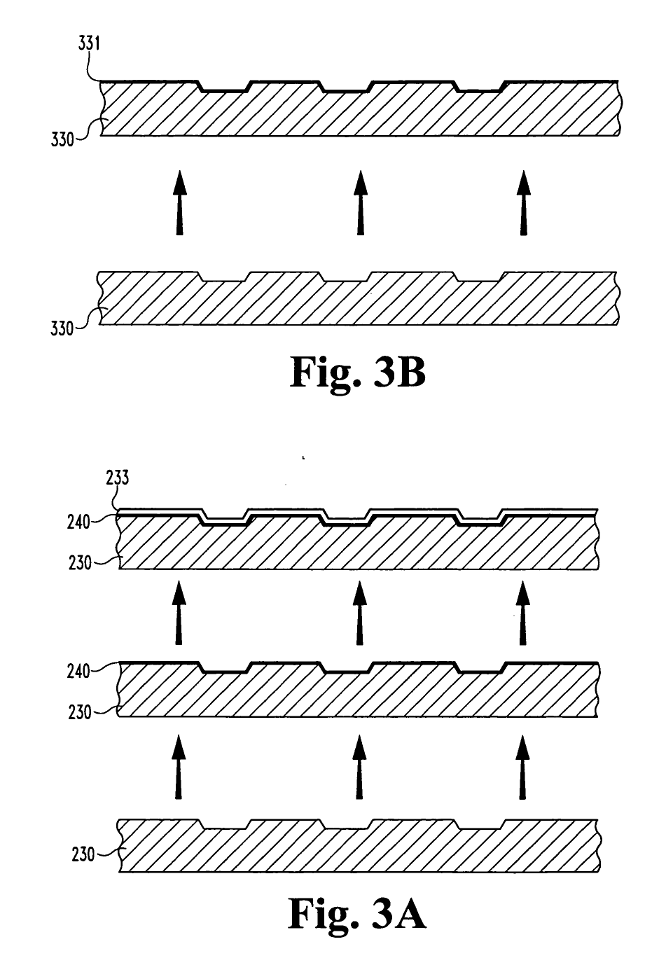

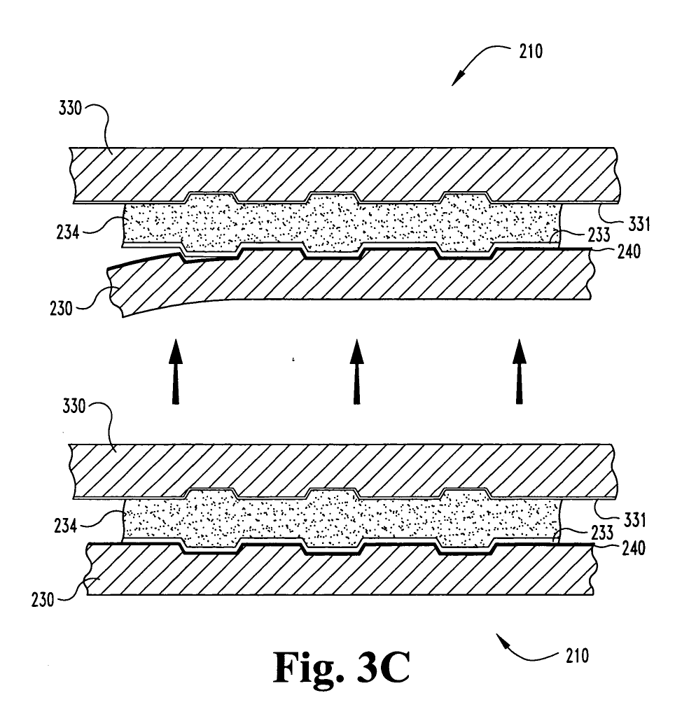

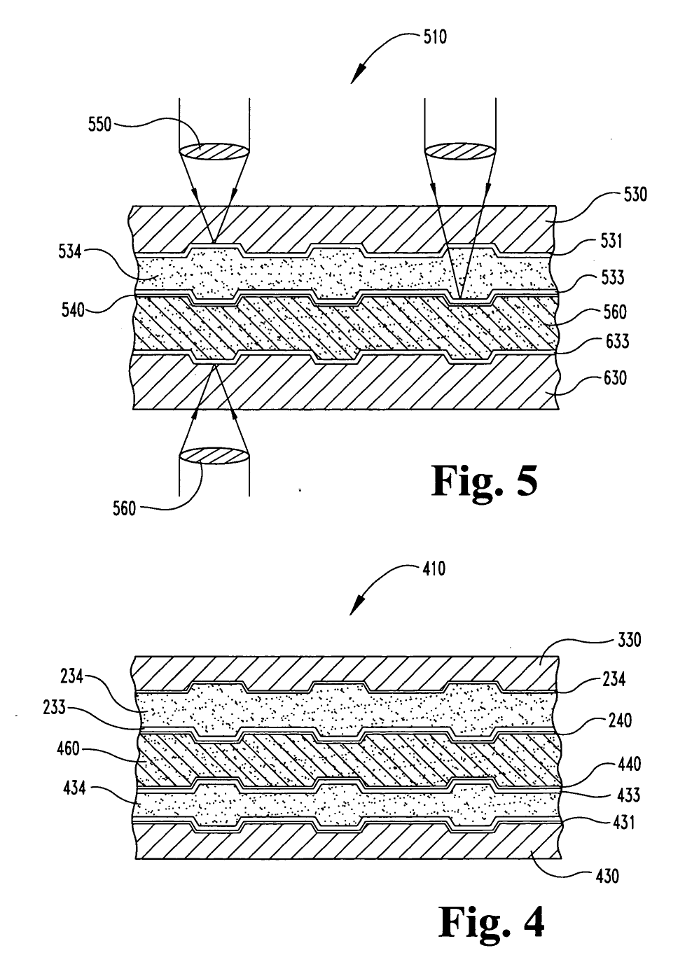

One embodiment provides a method of manufacturing an optical storage disc that weakens or eliminates the adherence of polycarbonate to the reflective layer by providing a “parting layer” between the polycarbonate substrate and the reflective layer. Referring now to FIG. 3, in one embodiment the parting layer facilitates peeling the polycarbonate substrate from the rest of the structure. Initially, two separate transparent substrates 230 and 330 made using, for example, polycarbonate are injection-molding and two distinct stampers (not shown) to transfer the information pits from the stamper to the substrate. Next “parting layer” 240 is deposited on polycarbonate substrate 230, followed by the coating of an aluminum alloy with thickness preferably in the range of 30 to 60 nanometers (nm). Substrate 330 is coated with a semi-reflective layer, typically made for example, from pure gold (preferably 12 to 17 nm thick) or a silver alloy 7 to 14 nm thick as disclosed in U.S. Pat. Nos. 6,007,889; 6,280,911; 6,451,402; or 6,544,616. Subsequently, in step 4, polycarbonate substrates 230 and 330 are glued together by an adhesive 234. The diameter of substrate 230 with “parting layer” 240 is larger than the diameter of substrate 330. In step 5, force can be easily applied to separate layers 230 and 330. The result is that substrate 230 made from polycarbonate is easily separated from substrate 330 using parting layer 240. Thus half-disc 210 with a semi-reflective information layer 331 and a highly reflective layer 233 can be made using an intermediate layer made from polycarbonate 230. Once removed the intermediate layer can be scraped or recycled. Next, two half-discs 210 (as illustrated in FIG. 3) can be bonded together to form a whole disc 410 with 4 information layers (as illustrated in FIG. 4). Referring to now to FIG. 4, both 330 and 430 are transparent substrates made with polycarbonate injection-molded from suitable stampers. Both 331 and 431 are semi-reflective information layers. Layers 234, 434 are typically UV cured adhesives or spacer layers. And layers 433 and 233 are the highly reflective layers typically comprised of aluminum alloy thin films with thickness in the range of 30 to 60 nm. Layers 240, 440 are residual “parting layers” of various embodiments of the invention and 460 is an adhesive, for example, of the hot melt type. The structure illustrated in FIG. 4 could be a structure with symmetrical disc structures on either side of 460, for example a DVD-18.

Alternatively, the structure illustrated in FIG. 4 could be a next generation optical disc such as the “Advanced Optical Disc” (AOD) or HD-DVD proposed by Toshiba and NEC. In this structure the substrates are made with two 0.6 mm half-discs, each with the capacity to store about 15 Giga-bytes per information layer. A laser with a playback wavelength of 405 nm is used in a player with a final objective lens that has a numerical aperture of 0.65.

Referring now to FIG. 5. Alternatively, the current invention can be used to make a tri-layer optical disc 510. Both 530 and 630 are transparent polycarbonate substrates. Both 533 and 633 are two different and highly reflective information layers. Layer 531 is a semi-reflective information layer. The adhesive 560 may be of the hot melt type. Parting layer 540 is of the current invention. The half-disc 210, includes two information layers after polycarbonate substrate 230 is peeled off. After the peeling step half-disc 210 is bonded to another half-disc with only one information layer. The two half-discs are glued together using adhesive 633. Next then a tri-layer disc 510 is made. Layer 633 is played back from one side, and layers 531 and 533 are played back from the other side. Parting layer 540 is on the back side of the highly reflective information layer and therefore will not be seen by the laser reading 550, and it will not affect the playback signal of highly reflective layer 533.

The physical characteristics of the “parting layer” requires that it be a material with a relatively weak affinity for the materials commonly used to form reflective layers in optical storage device and that is have low tensile strength. One class of materials that meets this requirement is soft metals such as, for example, elements such as pure gallium, thallium, tin, zinc, lead, cadmium, selenium, bismuth, antimony, and their alloys. The parting layer can be made from any one of the elements selected from the group mentioned above or from alloys made by combining the elements mentioned above. The word “pure” in this case typically means metal of commercial purity which is typically about 99.8 or higher according to ASM Handbook, vol. 2, page 518. According to ASTM specification B 339, a high purity commercial tin known as grade A tin is of a minimum purity of 99.85% tin. According to British Specification BS 3252, Grade T, commercially pure tin is minimum 99.8% tin. According to German specification DIN 1704, Grade A2, commercially pure tin is minimum 99.75% pure tin. Purity higher than the commercial purity of any of the above mentioned elements is preferred. Purity higher than 99.99 weight % is further preferred. Any of the metal alloys of gallium, thallium, tin, zinc, lead, indium, cadmium, selenium, bismuth and antimony with more than 85% by weight of the pure elements are acceptable. When the metal alloy is made with any of the above mentioned elements of more than 85% by weight, the second, third or any other combination of alloying elements are normally not critical. Preferably the elements used are selected from the group of elements mentioned above. The thickness of the parting layer could be in the range of 5 to 60 nanometers, although, to lower the cost of using the process, it is preferred that the thickness of the material to be on the low end of the range. In still another embodiment various metals suitable for use in parting layers can be combined with other materials including various other inorganic materials or organic materials.

Referring now to FIG. 3, a metal with relatively low tensile strength of the above mentioned composition is used as a parting layer first deposited on polycarbonate substrate 230. As illustrated in step 4 the parting layer is the weakest link in the layer stack. When polycarbonate substrate 230 is peeled from 330, the layers will likely separate at the parting layer interface.

Subsequently, half-disc 210 with two information layers and another half-disc with one information layer are bonded together to form the disc with three information layers such as the structure illustrated in FIG. 5. In another embodiment, half-disc 210 with two information layers and another half-disc with two information layers are bonded together to form the disc with four information layers such as illustrated in FIG. 4. Thus a disc with two transparent substrates and either three or four information layers can be manufactured using only polycarbonate substrates in the intermediate manufacturing steps. The use of soft parting layer eliminates the need to use PMMA. Depending in part on the composition of the materials used in the parting layer and in the rest of the disc structure the parting layer may be formed by any suitable process known in the art. For example, in one embodiment, the parting layer is deposited by thermal evaporation. In still another embodiment the parting layer is deposited by sputtering. As illustrated in FIG. 3, in at least one embodiment the preferred semi-reflective and the highly reflective layers 331, 233 are silver alloys.

Another class of materials that meets the soft material requirement are certain organic materials such as alkanes or alkenes or their mixtures with the number of carbon atoms per molecule ranges from 4 to about 20 or more. The only physical requirement is that at room temperature, the organic compound or compounds are a liquid which can be applied as a coating onto the polycarbonate substrate, for example, by thermal evaporation. The hydrogen atoms attached to the carbon atoms in the molecule can be primary, secondary or tertiary. This includes compounds such as isopentane, neopentane, 3-methylpentane, etc., which under some circumstances are suitable for use in forming a parting layer. Common distillation products from petroleum including compounds such as petroleum ether with carbon number C5-C6, ligroin with carbon number C6-C7, natural gasoline with carbon number C5-C10 and cycloalkanes, kerosene with carbon number C12-C18 and aromatics, gas oil with carbon number C12 and higher, lubricating oil with carbon number from 12 to about 30 attached to cyclic structures may be suitable for use in the formation of a, “parting layer”.

Essentially any organic compound, which exists as liquid at room temperature and which has melting points lower than 250 or 400° C. may be suitable for the current purpose which exhibits soft material characteristics. Paraffin wax, commonly used as material for candles, with melting point at around 50 to 55° C. is a typical example of this group of materials. Polycabonate substrate with the information side facing the heated organic material mentioned above for a few seconds is sufficient to coat the substrate with a few monolayers of the organic material which is sufficient to be used as the parting layer.

The above-mentioned novel multi-layer disc manufacturing process can also be used to manufacture other novel disc structure for the next generation of high-density optical data storage media.

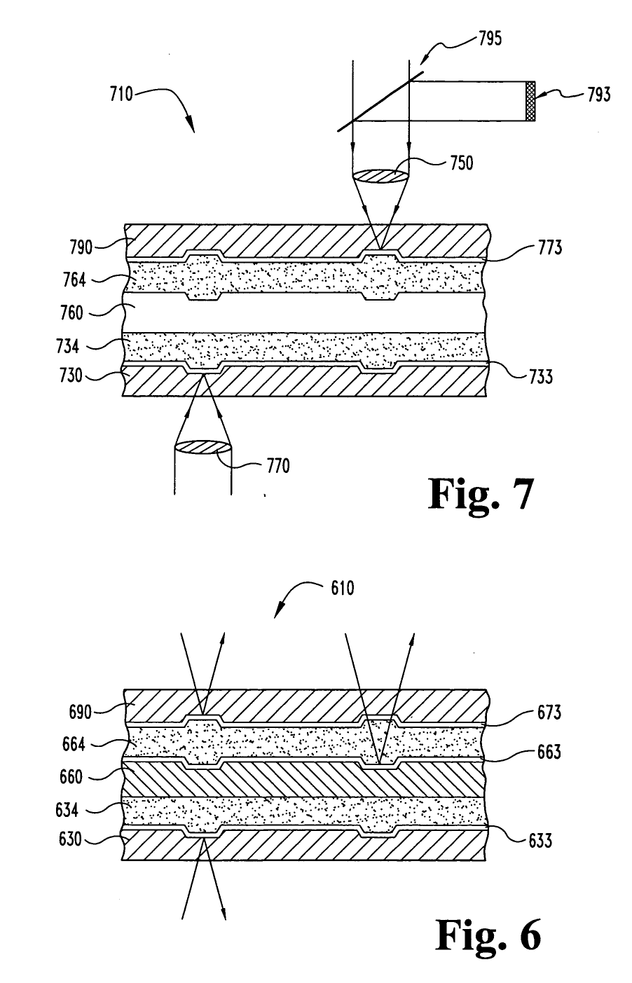

Referring now to FIG. 6, which illustrates still another embodiment of the invention, a new optical disc format hereby referred to as “Super Digital Disc” or “SDD”. Transparent substrates with information features or pits 630, 660, 690 are made with an injection molding process and suitable stampers. Each transparent substrate is about 0.35 to 0.42 mm thick. Information layers are labeled 673 or “L0”. A semi-reflective layer 663 (“L1”) made with a thin silver alloy 5 to 15 nm in thick, a highly reflective layer 633 (“L2”) made with a 20 to 60 nm thick silver alloy or aluminum alloy, a highly reflective layer made with 20 to 60 nm of silver alloy or aluminum alloy. Bonding materials 634 and 664 (adhesives) or spacer layers typically made of 40 to 60 nm thick of UV cured resins. The proposed playback laser wavelength is between 400 nm to 450 nm. The numerical aperture (NA) of the objective lens used to read the information pits is preferably between 0.65 to 0.78. Each information layer will have the capacity to store approximately 20 Giga-bytes of information. The preferred track pitch is from 0.35 to 0.40 microns, and the preferred minimum mark length is from 0.17 to 0.19 micron. Thus one embodiment of the disc structure illustrated in FIG. 6 includes three information layers and has a maximum storage capacity of about 60 Giga-bytes. In one embodiment, the disc diameter is between 11.5 to 12.5 cm and the total substrate thickness is between about 1.10 to about 1.34 mm.

As illustrated in FIG. 7, the three information layers can be degenerate. The device may comprise one ‘dummy layer’ 760 which contains no information. Transparent substrates 730, 760 and 790, either with or without information are preferably made with polycarbonate or amorphous polyolefins. Highly reflective layers L1 (773) and L2 (733) are preferably made with aluminum alloys or silver alloy thin films 20 to 60 nm in thickness, although other materials may be used. One method of manufacturing the disc is as follows. Substrates 690 and 660 are formed separately by injection molding, forming these substrates may include using two different suitable stampers. Substrate 690 is sputter-coated with semi-reflective layer “0” (L0); substrate 660 is sputter-coated with a highly reflective layer usually made from aluminum alloy thin film 30 to 60 nm thick, although other materials can be used. Next, the two substrates are bonded together using, for example, UV cured resin 664. Subsequently, substrates 660 and 690 are bonded together with substrate 630 (which is coated with a highly reflective layer 633) by using an UV cured resin 634. Typically, the highly reflective layer has a reflectivity of more than 75 or 80% and the semi-reflective layer has a reflectivity in the range of 15 to 30% at wavelengths in the range of 400 to 450 nm. Playback lens 750 or 770 focus the laser beam on information layers 773 or 733. Beam-splitter 795 and a photo-detector 793 are part if the device used to measure the playback signal. Thus, a disc structure with three information layers can be made. In one embodiment a three-layer disc structure has the capacity to store approximately 20, 40, or 60 Giga-bytes of information.

Typical disc manufacturing equipment that can be used to practice the embodiment illustrated in FIG. 7 includes molding machines, sputtering machines, and bonding machines. When dummy layers (substrates containing no information are used) the number of sputtering steps can be reduced to one or two. Since the thickness of one substrate is about half of the thickness of a conventional DVD half substrate, the molding time to make a 0.35 to 0.45 mm thick substrate is conceivably shorter than the current state of the art molding cycle time of 2.5 to 3.0 seconds per substrate. Shorter processing times mean greater efficiency and lower manufacturing costs.

The tri-substrate disc of the present invention has the further advantage that the disc structure is symmetric with respect to the middle substrate 660. See, for example, the embodiments illustrated in FIG. 6 or 760 in FIG. 7. This symmetry means that changes in ambient conditions will not significantly change the tilt or skew or the shape of the disc. This is a consideration in disc design, in part, because the transparent substrate material typically used in optical discs such as polycarbonate absorbs up to 0.2 to 0.3 weight % water in the ambient environment, which can warp the substrate. When the structure is symmetrical the effect of substrate warping will tend to cancel itself out resulting in a disc with a gross structure that has substantially the same tilt, skew and/or shape as the structure had before absorbing moisture.

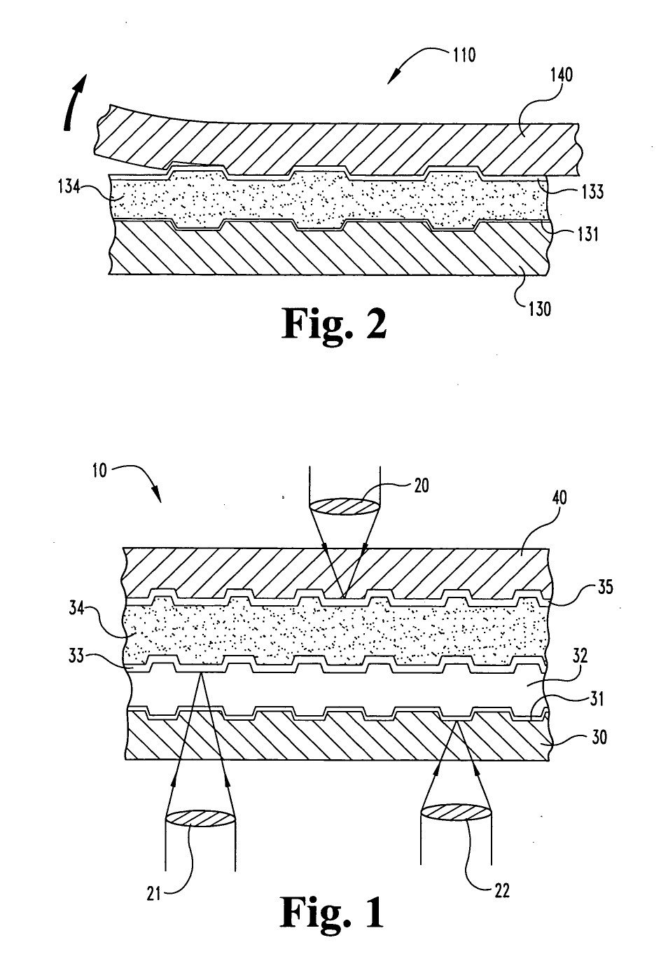

Still other embodiments are illustrated in FIGS. 6 and 7. The disc structures can be further modified to include an organic recording layer deposed between the transparent substrate and the highly reflective layer as in 773 or 733 in FIG. 7 or as in 633 in FIG. 6. These embodiments are analogous to the device described in Proceeding of SPIE, Volume 5069, Page 186, FIG. 1 and FIG. 2 for next generation optical disc such as Blu-Ray or AOD format. Differences between these embodiments and the blu-ray and AOD formats include that the transparent substrate of the embodiment has a thickness changed to between 0.35 to 0.42 mm and the player objective lens has a numerical objective changed to 0.65 to 0.78. A player laser with a wavelength of between 400 to 450 nm can be used with these embodiments.

Other embodiments of the invention include the media illustrated in FIGS. 6 and 7 and further modifying these devices to include a recording layer stack comprised of phase change material deposed between transparent substrate 790 and bonding layer 764. This is analogous to the layer stack illustrated in FIG. 2 and described in greater detail in the Proceeding of SPIE, Volume 5069, pg. 83. Furthermore a recording layer stack comprised of phase change material can be modified to accommodate the disc structure of an AOD or HD-DVD as illustrated in FIG. 1 of Proceeding of SPIE, Volume 5069, pg. 113, but with the substrate thickness, NA and player laser wavelength changed for use with some of the embodiments of the instant invention.

### EXAMPLE 1

Referring now to FIG. 6, one embodiment is a manufacturing process suitable for making optical storage media that includes multiple information layers such as, for example, a DVD-14. Two 0.6 mm thick polycarbonate substrates are formed by injection molding using and stampers to form separate substrates 230 and 330. Substrates 230, 330 each have separate information features. Substrate 230 is subsequently sputter coated to form a “parting layer” 240 that is 5 nm thick. The target used to form the parting layer on 240 is made with tin that has a minimum purity of 99.99% by weight. Afterwards, substrate 230 is sputter coated to form a 35 nm thick semi-reflective layer. The sputtering target used to form the semi-reflective layer on 230 is a silver alloy comprising: 1.1% by weight copper and 98.9% by weight of silver. Substrate 330 is coated with a 10 nm thick semi-reflective layer. The composition of the sputtering target used to form the semi-reflective layer on substrate 330 is the same as composition of the sputtering target used to from the semi-reflective layer on substrate 230.

Referring now to FIG. 4. The two 0.6 mm substrates are glued together using a UV cured resin such as the one provide by Nippon Kayaku DVD-611. The diameter of substrate 230 is made slightly larger than the diameter of substrate 330 to facilitate separation by mechanical force of the two substrates as illustrated in Step 5. Next, another substrate similar to 210 is made with the same steps mentioned above. Both of this substrate's surfaces are coated with a parting layer. The parting layers are comprised of tin. One parting layer is coated with a protective layer made from, for example, a typical UV resin used in the construction of CDs. The other parting layer is coated with a UV resin typically used screen-printing, using a screen printing machine. Finally, the two polycarbonate substrates, each having two information layers, are joined together to form a complete DVD-18 disc.

### EXAMPLE 2

The embodiment illustrated in this example is similar to the embodiment illustrated in Example 1, except that the parting layer is made from a sputtering target of antimony with a purity of about 99.99% weight minimum applied by a sputtering process.

### EXAMPLE 3

Example 3 is similar to Example 2, except that the parting material is applied by sputtering using a sputtering target comprising lead with a minimum purity of about 99.99% by weight. Substrate 210 with two information layers 233 and 331, and another 0.6 mm polycarbonate substrate with only one information layer having a reflective layer made of an aluminum alloy of 45 nm thick are joined together. As illustrated in FIG. 5 the finished disc comprises three information layers.

### EXAMPLE 4

Example 4 is similar to 1, except that the parting layer is sputter-coated from a sputtering target made from bismuth with a minimum purity of about 99.99% by weight.

### EXAMPLE 5

Example 5 is similar to 3, except that the parting material is sputter-coated from a sputtering target of bismuth tin alloy comprising about 57% by weight bismuth and about 43% by weight tin.

### EXAMPLE 6

All process described in Example 6 is similar to the process described in Example 1, except that the parting layer is applied by a thermal evaporation process of an organic compound conducted in air. The organic material used to form the parting layer is made from a paraffin wax with melting point of 53° C.

### EXAMPLE 7

Referring now to FIG. 6. A manufacturing process to make the one disc of the instant invention will be described. A 0.37 mm thick polycarbonate substrate is formed by injection molding using a suitable stamper. Then a semi-reflective layer in the form of a silver alloy thin film 10 nm thick is coated on the surface by is sputter-coating using a sputtering target with the following composition, 1.0 weight % copper, 0.2 weight % silicon and balance silver. Next, a second 0.37 mm thick polycarbonate substrate is injection-molded and using a suitable stamper to from a second substrate. Using a sputtering target with the same composition as the aforementioned target to from a 30 nm thick silver alloy film on the second substrate. The two substrates are then bonded together with a UV curable resin such that the two information layers face each other. Subsequently, a third 0.37 mm thick polycarbonate substrate is injection molded using a third stamper with suitable information pits to from a third substrate. The third substrate is sputter-coated with another layer 30 nm thick silver alloy thin film. The structures are then bonded together with the substrate assembly 660, 663, 664, 673 and 690 using an UV curable resin to form the complete disc 610. Disc 610 can be played back by a player with a laser beam of wavelength 405 nm through an objective lens with a numerical aperture (NA) of 0.70. Layers 673, 663 can be played back with a one laser pick-up system from the same side. The disc can be withdraw from the player and reinserted in the player such that the playback laser faces layer 633. Disc 610 has a storage capacity about 20 Giga-bytes per layer, measured signals from the disc will have sufficient quality to serve as a new disc system.

All publications, patents, and patent applications cited in this specification are incorporated herein by reference as if each individual publication, patent, or patent application was specifically and individually indicated to be incorporated by reference and set forth in its entirety herein.

Unless specifically identified to the contrary, all terms used herein are used to include their normal and customary terminology. Further, while various embodiments of optical storage devices and methods for their manufacture and use steps are described and illustrated herein, it is to be understood that any selected embodiment can include one or more of the specific components and/or steps described for another embodiment where possible.

Further, any theory of operation, proof, or finding stated herein is meant to further enhance understanding of the present invention and is not intended to make the scope of the present invention dependent upon such theory, proof, or finding.

While the invention has been illustrated and described in detail in the drawings and foregoing description, the same is to be considered as illustrative and not restrictive in character. It being understood that only the preferred embodiments have been shown and described and that all changes and modifications that come within the spirit of the invention are desired to be protected.

1. A multi-layer optical storage medium, comprising:
a first transparent substrate having a pattern of features in at least one major surface;
a semi-reflective layer adjacent to said feature pattern, said semi-reflective layer including a metal alloy;
a spacer layer adjacent said semi-reflective layer;
a highly reflective layer adjacent said spacer layer;
a parting layer adjacent said highly reflective layer, said parting layer comprising a material having a relatively low affinity for said highly reflective layer.

2. The multi-layer optical storage medium of claim 1, wherein said parting layer includes a metal selected from the group of metals consisting of: gallium, tin, zinc, lead, cadmium, selenium, bismuth, tellurium, and antimony and mixture thereof, wherein the metal alloy is at least of 85.0% purity.

3. The method of claim 1, wherein said parting layer comprises an organic material selected from the group consisting of hydro-carbons molecules with number of carbon atoms per molecule ranging from 5 to 30.

4. The multi-layer optical storage medium of claim 1, further including;
a second transparent substrate having a pattern of features in at least one major surfaces;
at least one highly reflective layer adjacent said feature pattern of said second substrate; and
at least two spacer layers, wherein said spacer layers are positioned between said first and second substrates.

5. The multi-layer optical storage medium of claim 1, wherein said semi-reflective layer comprises a silver alloy including metals selected from the list consisting of copper, zinc, titanium, manganese, tin, indium, cadmium, aluminum, silicon, germanium, zirconium, lithium, chromium, antimony, gallium, bismuth, molybdenum, and mixtures thereof, said silver alloy has a minimum purity of 90% by weight.

6. The multi-layer optical storage medium of claim 1, wherein said semi-reflective layer comprises a silver alloy, including metals selected from the list consisting of copper, zinc, titanium, manganese, tin, indium, cadmium, aluminum, silicon, germanium, zirconium, lithium, chromium, antimony, gallium, bismuth, molybdenum and mixtures thereof, wherein said silver alloy has a minimum purity of 90% by weight of silver.

7. The multi-layer optical storage medium of claim 2, wherein said metal in said parting layer is a metal of commercial purity of at least 99.85% by weight.

8. The multi-layer optical storage medium of claim 2, wherein said metal in said parting layer is a metal with a purity of least 99.95% by weight.

9. A method of making a multi-layer optical disc comprising the steps of:
a) molding a first substrate having a pattern of features in at least one major surface, coating said first substrate with a parting layer, and coating said parting layer with a highly reflective layer;
b) molding a second substrate having a pattern of features in at least one major surface, coating said feature pattern of said second substrate with a semi-reflective layer; and
c) bonding said first substrate and said second substrate together with an adhesive such that said highly reflective layer is bonded to said second substrate structure and said highly reflective layer is transferred to said second substrate structure when said highly reflective layer is separated from said parting layer leaving said second substrate with two layers of feature patterns.

10. A method of making a multi-layer optical disc according to claim 9, wherein said parting layer comprises a metal selected from the group of metal consisting of: gallium, thallium, tin, zinc, lead, cadmium, selenium, bismuth, antimony and their mixtures thereof, wherein said metal is at least 85% purity.

11. The method of making multi-layer optical disc according to claim 9, wherein said first substrate and second are both molded from polycarbonate.

12. An optical information recording medium comprising:
a first substrate having a first information surface;
a semi-reflective layer formed on said first information surface;
a second substrate having a second information surface;
a highly reflective layer formed on said second information surface of said second substrate;
a first adhesive bonding layer;
a third substrate having a third information layer;
a highly reflective layer formed on said third information layer; and
a second bonding layer; wherein said first and said second semi-reflective layers on said first and said second substrates face each other, said first and said second substrates are joined by said first bonding layer, said second substrate is joined to said third substrate by said second bonding layer such that said highly reflective layer of said second substrate faces in the direction opposite from said highly reflective layer of said third substrate.

13. The optical storage medium according to claim 12, wherein the total thickness of all said substrates and said layers is <1.34 mm, >1.10 mm, the thickness of said adhesive layer is ≧30 microns, and the diameter of said information storage medium is ≧11.5 and ≦12.5 cm.

14. The optical storage medium according to claim 12, wherein the thickness of each said substrate is ≧0.35 and ≦0.42 mm.

15. The optical storage medium according to claim 12, wherein the semi-reflective layer comprises a silver alloy said silver alloy includes elements selected form the group consisting of copper, zinc, tin, titanium, manganese, indium, cadmium, aluminum, silicon, germanium, zirconium, lithium, chromium, antimony, gallium, bismuth, molybdenum and mixtures thereof, wherein said silver alloy has a minimum purity of 90% by weight of silver.

16. The optical storage medium according to claim 12, further including:
at least one recording layer between any of said substrate and highly reflective layer, wherein said recording layer comprises an organic material.

17. The medium in claim 16, wherein the organic said organic material is a dye, wherein the dye is selected from the group of cyanine, azo, phathalocyanine and mixtures thereof.

18. The optical storage medium according to claim 12, wherein there is at least one recording layer between said two outer substrates, said recording layer includes at least an inorganic recording layer and at least two dielectric layers sandwich said inorganic recording layer.

19. An optical playback system comprising:
an optical pick-up head with at least one laser emitting light in the wavelength range from 400 to 450 nm;
at least one objective lens with a numerical aperture in the range of 0.65 to 0.78;
a focusing servo-mechanism to read at least two information layers separated by at least 30 microns;
a tracking mechanism to follow information pits in a continuous spiral; and
a decoding system for converting analog light intensity signals into digital signals and then converting said digital signal into an image display signal for viewing.
